(19) United States
(12) Patent Application Publication
(10) Pub. No.: US 2015/0058103 A1
(43) Pub. Date: Feb. 26, 2015

(54) SOCIAL MEDIA INCENTIVE POINT MANAGEMENT

(71) Applicant: David Kirk, Washington, DC (US)

(72) Inventor: David Kirk, Washington, DC (US)

(73) Assignee: DCA VENTURES, Washington, DC (US)

(21) Appl. No.: 14/289,641

(22) Filed: May 28, 2014

Related U.S. Application Data
(60) Provisional application No. 61/827,796, filed on May 28, 2013.

(51) Int. Cl. G06Q 30/02

(52) U.S. Cl. CPC G06Q 30/0214
USPC 705/14.16

(57) ABSTRACT

The systems and methods described herein relate to computerized incentive management including a unified and centralized program whereby individuals with social media accounts (users) can earn points for interacting with various social media sites according to parameters set by a sponsor. The system can be configured to identify qualifying social media interactions based on a wide variety of flexible factors.

### CROSS-REFERENCE TO RELATED APPLICATIONS

This application hereby claims priority under 35 U.S.C. section 119(e) to U.S. Provisional Application Ser. No. 61/827,796, entitled “SOCIAL MEDIA INCENTIVE POINT MANAGEMENT,” by inventor David Kirk and filed on May 28, 2013, the contents of which are herein incorporated by reference. This application is also related to U.S. Application Ser. No. 61/820,306 filed on May 7, 2013, entitled “SYSTEMS AND METHODS FOR SOCIAL MEDIA INCENTIVE MANAGEMENT,” the contents of which are hereby incorporated by reference.

### BACKGROUND OF THE INVENTION

Social media is increasingly popular and many enterprises are actively promoting the use of social media engagement by their customers and potential customers. Nonetheless, enterprises are finding that simply advertising the fact of their presence on social media is insufficient to drive the desired level of enagement. Thus, more compelling programs are needed to further engage individuals on social media and promote a more substantial engagement.

### BRIEF DESCRIPTION OF THE DRAWINGS

FIGS. 1 and 2 illustrate a flow diagram for social media engagement and point management.

FIG. 3 illustrates an example database structure for managing the system.

FIGS. 4-8 illustrate example modes of operation of the system.

FIG. 9 illustrates an example system and method for social media point tracking

### DETAILED DESCRIPTION

The systems described herein relate to a computerized incentive system. The system can provide a unified and centralized program whereby individuals with social media accounts (users) can earn points for interacting with various social media sites according to parameters set by a sponsor. The system can be configured to identify qualifying social media interactions based on a wide variety of flexible factors.

The systems can employ different point scales based on multiple factors and use complex interdependent methods for assigning point valuations for different social media activities. The systems can be used to promote a conversation among users about a sponsor's products or services. In particular, the systems are capable of promoting trustful and honest feedback about the sponsor's offerings. As used herein, the terms “sponsor,” “company”, “organization,” “non-profit,” “business,” and similar terms, as used interchangeably to denote any type of entity.

While example systems and methods described herein can be applied to social media networks, they could also be applied to other forms of computerized communications, such as a company website, or any existing interactive media. As a non-limiting example, it could be applied to the comments section of a newspaper site. While the examples described herein can be executed on the Facebook™ platform, the systems and methods could also be deployed on any other media or platform by which an exchange between users is permitted to take place. The same or corresponding functionality described herein can be provided to any network of users and sponsors. Other media platforms could include, as non-limiting examples, public social networks, private social networks, websites with comment forms, etc. The systems and methods described herein could be implemented on, for example, social media networks, third-party websites, and/or other online portals.

Point Systems

The system can award points to users based on their social media interactions. As non- limiting examples, the point systems can include features such as:

Collecting points from Facebook™ for different activities (e.g., posting, commenting, liking) within Facebook™;

The conversational functionality which allocates different point values to users based on follow-up comments and likes from other users in an ongoing discussion thread, and allows users to accumulate additional points as follow-up comments are added to the conversation thread;

The administrative backend and mirror Facebook™ wall and scoreboard;

The starting and stopping of activity cycles during which points are collected;

The collection and export of activity metrics and analytics;

The code corresponding to the Facebook™ login process that integrates users into the point system;

The code corresponding to the removal of posts/comments/likes and subsequent deletion of points;

The code corresponding to the communication between the Application, Facebook™, and the administrative backend; and

The code corresponding to the Point leaderboard in the administrative backend.

As described in more detail below, the system can be configured to reward a user with points based on pre-configured social media activities being performed by the user.

The point system implemented can be arbitrarily complex or simple depending on parameters set by a program administrator affiliated with the sponsor. For example, a user may receive some or all of x points for originating a post in a discussion, y points for liking a discussion, and z points for posting a follow-up comment in a discussion. Point values can be pre-assigned, calculated based on initial parameters, and/or calculated on the fly during execution of the program.

As non-limiting examples, points can be given to users for any or all of posting multimedia content, for tagging individual users, checking in, etc. For example, points can be assigned based on the type of interaction, including but not limited to, liking, commenting, posting a photo, tagging an object, posting a video, etc. Points can also be given to users based on user activities such as opening sponsor emails, using certain Twitter™ hashtags, and viewing specific Internet-accessible content. These different types of interactions can be assigned different point values. Some types of interactions may receive zero points, some more than one point, or factional points. Point valuation schemes can be used to promote conversation among social media participants by assigning greater point values to those types of interactions. Point valuation schemes can be used for incentivizing customer feedback, employee and product evaluations, and to run online virtual focus groups, among other activities.

The point values may be any integer or fractional value. The values may be mathematically related to each other or may be chosen independently. Points can also be given for offline events. As non-limiting examples, offline events can include hosting and attending events. As described herein, offline events can be recorded in the system by manually entering them. Once entered, the accumulative value of the points for offline events can be calculated by the system and displayed to a user and/or administrator.

An example schedule for point valuation is provided below:

Posts: An original post, which starts a thread with text, a photo, a video or a link, earns 3 points.

Comments: A text, photo, video or link comment which follows a post earns 2 points.

Likes: A like on a post earns 0.5 points. (Likes on posts, or on a user's own comments can be configured to not earn points.)

Conversation: Members receive additional points for ongoing conversation. Methods for allocating points in conversation are discussed in more detail below.

Bonus points can be awarded for certain activities that take place outside of a social media group. For example, publishing an article on a sponsor blog could earn 100 points.

While the term “point” is used herein, any other terminology that is capable of representing value accretion could be used interchangeably, such as “score,” “value,” “balance,” etc. As used herein, a “point” can refer to a whole point, a factional value of a point, a point value larger than 1 but having a factional component, multiple points, or any combination of these values.

Point Schemes

The system can be configured to offer multiple point schemes in which points are awarded based on the relationship of a social media activity within the context of other social media activities. Specifics of the point schemes can be pre-defined in the system or generated by a user (such as an administrator). In some embodiments, the point schemes can be edited using a point structure administration tool, such as that described in more detail below.

In some embodiments, the system can be configured to track multiple different types of points. Types of points can include those awarded based on a user's actual posting (“direct points”), and those awarded based on subsequent engagement by another user (“indirect points”), and those awarded based on a series of enagements (“conversational points”). Some points may be overlap and be of multiple types. Examples of these types of points are described in more detail below.

Direct Points Features and Methods

In some embodiments, the system can award points to a user based on an activity performed directly by that user. In this configuration, a user can be awarded points for doing something on the social media platform, such as posting, commenting, liking, etc. For example, a user (“User A”) could initiate a post with a comment on the quality of service by a certain vendor. A user (“User B”) could subsequently like the User A's post about the quality of service. A configurable number of points could be awarded to User A based on the initial posting. A configurable amount of points could also be awarded to User B based on the liking of the initial post. These points awarded to users in response to their own activities are considered direct or active points. In some embodiments, the ability to award direct points can be disabled.

Indirect Points Features and Methods

In some embodiments, the system can be configured so that a user is awarded points based on the activity of others. For example, a first user can be awarded points when other users take an action in response the first user. In this configuration, a user can post, but will not receive points until someone else interacts with that post (by for example, commenting or liking that post). As a non-limiting example:

User A Posts (User A gets 0 points because User A initiated the content),
User B Likes (User A gets 1 point, User B gets 0 points),

User B Comments (User A gets 2 points, User B gets 0 points),

User C Comments (User A gets 2 points, User B gets 2 points, User C gets 0 points).

Conversational Point Features and Methods

The system can be configured to provide points based on an arbitrarily complex sequence of social media interactions. As discussed above, points can be awarded based on a single social media event. Points can also be awarded based on the context of the social media event.

In some configurations, the original poster may receive points both for starting a new discussion thread and for each time another user posts a follow-up to that initial posting, such as a comment or a like. In some embodiments, all of the earlier posters in a thread may receive points according to a schedule each time a subsequent interaction or post is made in the thread. Point multipliers can be configured for likes and comments relating to a user's post. The point value received by the user for the original post may be greater than the point value received by the user for a follow-up interaction by another user. In some cases, a maximum can be defined to limit the number of points a user can earn from initiating a given social media interaction.

As a non-limiting example, the system can be configured so that the user with an original post receives 1 point compounded for a new comment and users who comment can receive 1 point compounded for every comment following their own. The system can be configured to award points for a defined or configurable number of responses. In some embodiments, a user can receive a point for each comment (or like or other interaction) in response to an original post. In those embodiments, the points could accumulate indefinitely. In other embodiments, the system can be configured so that the points stop accumulating after a specified number of points have been accumulated, or after a certain amount of time has passed since the original post, or after a specified number of posts have been made.

The system can be configured so that a user in a conversation thread continues to collect points as the conversation continues. The user who started the thread can continue to accumulate points as additional users comment, like, or otherwise interact in the conversation thread. In addition to the initial poster accumulating points, users who contribute a comment (or other interaction) can also start to accrue new points as other users add to the conversation. So if a first user starts the first post, and a second user comments, both the first and second users receive points. As a third user adds a comment, both the first user and second user accumulate conversation points.

For example, the data can be processed in such a way that a first comment by a user will accrue 2 points to the post owner, and 2 points to the user who has commented first, and 1 point to any other users who have interacted with the discussion thread. The system can be configured so that follow-up points are only added for new user's comments, thereby preventing users from colluding to keep commenting on each other's posts to collect large numbers of points. In those configurations, multiple comments by single user can be considered as one interaction while allocating aggregate points but may be given ×2 for each comment.

Interactions in a conversation can have different activity possibilities. For example, a comment can be followed by a video, which is followed by a photo. As an additional example, the system can be configured so that points awarded in a conversation can have different valuations based on the different activities. As non-limiting examples, the following point schedule could be used: one point for a follow-up comment, three points for a follow-up video, two for a follow-up photo, etc. This type of schedule can be used to promote users interaction with one another in a dynamic way.

Point Structure Administration

An interface can be provided to a user, such as an administrator. The interface can include configuration options for constructing and/or modifying point schemes. The interface can include control elements for identifying and/or selecting a social media activity (such as, for example, liking a post) and associating that activity with a points value. In some embodiments, the system can include configuration options so that an administrator can select which types of points may be awarded and accumulated (direct, indirect and/or conversational). In those embodiments, the system will then award and track the selected types of points.

Points can be tracked by administrators and users based on whether the points are direct, indirect or conversational points. In some embodiments, direct points can be tallied and used as a qualifier. For example, a restriction can be placed so that indirect and/or conversational points accrue in an ongoing manner, but users are only eligible to receive the associated awards once they earn a certain number of direct points. In another example, the system can be configured so that users start earning indirect and/or conversational points only after the user has earned a certain number of direct points.

The interface for point structure administration can be provided as part of the sponsor portal, described in more detail below.

User Portal

The system may include a centralized portal (also referred to as a dashboard) for a user where some or all of the user's points can be managed and monitored by the user. The portal can be configured to track points accrued on multiple and/or diverse social media platforms, such as Facebook™, LinkedIn™, Yelp™, Twitter™, Trip Advisor™, and others. Thus, the system can offer a unified portal so that the user does not need to access multiple different sites, with potentially multiple different login credentials, to manage the points. Though the user portal, the user can have access to the user's points, other statistics, and the user's standing in a competitive campaign.

For example, the system can be configured so that a user can participate in the programs by authenticating on a third-party website to login to the system. After that, the interaction with the user can take place within social media networks and does not require further visiting the third-party website. Once authorization is established on the third-party website, the user can engage without manual login from other computing devices. In some embodiments, the system can be configured so that a user can access the user dashboard within the social media sites, without visiting the third-party website.

In one example embodiment, a user can visit a sponsor site and perform a one-time login which collects fields of information, including name, address, phone email, and existing loyalty account numbers. By collecting the existing loyalty account numbers, the system can link the rewards account to existing loyalty accounts. In some embodiments, the system can auto-populate the rewards account information based on information available from the loyalty account. The system can also collect demographic information at that time.

The information collected can be stored in a profile at the administrative backend. Using Facebook™ as an example, the portal can also request access approval to join the Facebook™ page of a sponsor. The sponsor can configure the system to auto-approve users meeting certain criteria. If accepted, a user can be sent an email with a link to a login. The user can then sign-in with Facebook™ and enable the incentive system to access the user's Facebook™ account. On other social networks, corresponding functionality can be provided to allow access requests and approvals.

The user then joins the Facebook™ group or page. The Facebook™ page or group can be open or closed. Users can post on the Facebook™ page and the postings can be collected and points tabulated according to the valuation schemes described herein.

In some embodiments, the user portal can include functionality for redeeming points as rewards. As non-limiting examples, the rewards offered can be many small items or larger single items.

The user portal can include functionality for calculating and displaying a current point total. A user can select an “Update Points” link in administration panel. The Facebook™ feed is then retrieved with the limit of, for example, 100 posts per request. The feed retrieved from Facebook™ can be split into posts. Post can then be processed separately to compute points based on the activity. The points are assigned to the users based on their corresponding activities.

As an example, a post array can have following key values for identification:

$feed[‘created time’] to identify the post's created date and time;
$feed[‘type’] to identify if a post is a video or photo or link or status;
$feed[‘comments’][‘data’] has the details of all the comments on the post.

The processed feed data can be saved in an array. Once the feed of current cycle ends then the array is returned to the action method. The points can be saved in point table for each user.

For frontend display and administrative reports, points are retrieved from a database table. The date displayed indicates the date and time when the points were last updated.

Social Media Integration

The user portal may be separate from, or combined with, systems for integrating with proprietary social media websites. The points awarded can be allotted to an associated social media account. In some example systems, a user may visit a sponsor's website. On that site, the user may login to the sponsor's website using social media account credentials. The user portal may be provided on the sponsor's website or on the social media site directly.

The system also can be configured mirror social media activity on a third-party site. As a result, a user can track points and/or execute social media interactions there. For example, a Facebook™ wall can be beamed onto a third-party site where interaction can take place.

The system can also be configured to track and reward actions that take place outside of social media (e.g. writing a blog post). In some embodiments, information about these other activities can be manually entered into the points database, thus facilitating the aggregation of information, points, and/or analytics in one common place. In alternative embodiments, the system can be configured to automatically identify actions taking place outside of social media and automatically aggregate points for those activities in the user's account.

Sponsor Portal

The system may also include a dashboard or portal for the sponsor. The sponsor can be any organization that is promoting the use of the social media. In some cases, the sponsor may be a corporation. The various social media programs by the sponsor can be organized into campaigns. For example, a campaign could be for users to take pictures of themselves at departure terminals in airports. The sponsor portal can be used by the sponsor to view summaries of the campaigns. In this example, information summarized can be the total number of pictures submitted and the total number of points awarded. The sponsor may, at its election, allow users to redeem points in exchange for, as non-limiting examples, goods, services, cash, or awards in an existing awards system (e.g., miles, hotel points, etc.).

Thus, the sponsor portal enables a quantitative assessment of the success of failure of a social media campaign. As points are awarded for qualifying social media interactions, the points can be monitored in connection with that campaign. As described in more detail below, the social media interactions can be subject to sentiment analysis. Thus, the social media campaign can be quantitatively assessed with respect to its ability to generate positive (and negative) feedback in social media.

The sponsor portal can display any or all of the information and statistics of any individual users, any or all user information, standings, and advanced data metrics based on multiple variables.

The sponsor portal can be configured to identify qualifying social media interactions based on a wide variety of flexible factors. The identification does not need to be limited to predefined, or stock, phrases.

In some embodiments, the sponsor can create a virtual currency.

The sponsor portal can be used to sort the social media interactions that generate the largest number of interactions (such as likes, replies, etc.). A sponsor can sort based on various point metrics. The sponsor portal can be used to delete posts and/or points in Facebook™ and cause deletion of corresponding points in the user's account. The sponsor can configure the portal to automatically remove users if the user has a threshold number of posts deleted. The sponsor can add bonus points based on arbitrary activities, such as, for example, submitting a blog post on another site while using a linked profile.

The system can be configured to automatically deduct points based from a user's account upon the deletion of actions within the social media page and/or group. Deletion of the action can trigger a corresponding deletion of points that had been assigned previously, in the administrative section or by other means, and update the analytics accordingly.

The sponsor portal can be configured to automatically generate communications based on the point levels achieved by users. For example, a communication stating “You've achieved Gold level,” or “Only 100 points remaining until next level” could be automatically sent based on the user's points level. The content of the message could alternatively be delivered by a message within the social network itself, or by email.

The sponsor portal can be used to configure promotion cycles. The promotion cycles can indicate point collection start and stop dates and times. In some embodiments, the start and stop dates and times can be preset to automatically start and stop or can be manually managed.

Metric Tracking and Sponsor Portal

The sponsor portal can be configured to track various cost-benefit metrics. As a non-limiting example, the sponsor portal can be configured to track redemptions and social media interactions by individual users.

The cost/benefit metric section can track the effectiveness of the social media reward schemes. The sponsor can enter the costs of rewards offered and staffing time dedicated to the reward program. This information can be displayed alongside the result metrics.

As a non-limiting example, in a car giveaway, the sponsor enters the cost of the car, the cost of staffing resources put into the reward, and the cost of marketing/advertising associated with the initiative. The sponsor can also enter desired goals (e.g., number of new likes, number of video posts, number of photos posted, etc.) The portal can then synthesize this with the actual numbers of likes, videos, etc., and do the same for multiple campaigns. Using this functionality, the sponsor can compare different reward campaigns with real results, in one location.

The portal can also be used to track actual customer spending on products as it pertains to their social media activity. This can include linking the portal to the sponsor's own database (using reward number, account number, etc. collected in the intake stage as described above). When the user makes new purchases they are automatically accounted for in the portal, alongside the social media metrics so the sponsor can track if levels of social media engagement lead to more spending, or different types of reward campaigns lead to more spending, etc.

The portal can include a method for generating SQL queries to fetch the points details for the users such as: total points in the current cycle, deleted points, net points in current cycle, and total points in all cycles.

Employee Feedback Models

Some embodiments of the system may configure sponsor customer service representatives as users who are able to receive points for being positively mentioned in a social media interaction. The structure for employee incentive points may be unrelated to, and separate from, the incentive point program structure for customer users.

In some embodiments, points may be given to a customer, and employee, and/or an employee supervisor. Additionally, points could be awarded to a branch of a business.

To facilitate the generation of employee feedback, employees, branches, or stores could provide identifying cards to users. Alternatively, a tablet computing device, such as an iPad, could be provided at the point of customer interaction. The tablet could show the user the employees in a directory. Alternatively, QR tags could be used. The user could then be rewarded for making the interaction. In those embodiments, points for mentioning certain keywords relating to the business or for identifying a specific employee can be awarded. In some embodiments, the employee of the sponsor may also be given points based on the user's social media interaction. In some embodiments, the employee may be given points based on whether the interaction was positive, as described below in connection with determining user sentiment. In some embodiments, points may be subtracted from an employee's account based on a user's posting having negative sentiment and points may be added to an employee's account based on a user's posting having positive sentiment.

Some embodiments can be configured to prompt a user to use different hashtags or emoticons to indicate positive and negative experiences. Pre-determined keywords, hashtags, and emoticons can be managed on the sponsor portal, and displayed to the sponsor in separate columns in some embodiments. The system could collect the positive and negative, and an administrator can review and adjust the categories.

In some embodiments, an automatic email could be generated upon check-in by a user, prompting user to rate the experience using social media. This data can then be collected as described above and displayed in the portals.

Determining User Sentiment

Some embodiments can be configured to qualitatively determine user sentiment by interpreting the social media interaction to determine whether a social media interaction is positive or negative with respect to the sponsor.

Some embodiments of the system can be configured to distinguish between positive and negative social media posts and interactions. The system may also directly collect copies of the social media interactions for subsequent qualitative and quantitative analysis.

In some embodiments, the system can track certain emoticons indicating positive or negative sentiment (such as a smiley face or frowning face) and tracking those to determine positive or negative reactions. In some embodiments, one or more emoticons could be displayed on the user dashboard indicating what the emoticons mean, providing instructions on how to enter them, and how many points a user will earn for using the emoticons. In some embodiments, users can be rewarded with different point valuations for using the emotional indicators. The emoticons can include, as a non-limiting example, a smiley face, but are not limited to a smiley face. Any kind of sign and/or sequence of letters and/or numbers that is determined to mean something can be used as an emoticon.

A word list comprising relevant terms may be generated for particular contexts or subjects. According to some embodiments, the word list and associated sentiment scores can be stored in a data structure for use when analysis of the text content is performed. Analysis of the text content can identify relevant terms, which include those terms that are candidates for conveying user sentiment. The relevant terms may also include a subject of the text content (e.g., identification of the sponsor's business).

Natural language processing and computational linguistics can be used to perform automated sentiment analysis on items. Using a sentiment analysis engine, content may be evaluated using, in some examples, natural language processing to identify features, sentiments (e.g., “comfortable,” “nice,” “warm,” “cool,” “hot,” “great,” “poor,” and other attributes, without limitation), or other factors that are associated with a given sponsor offering.

One or more sentiment values can be determined for the analyzed text content. The sentiment value determination may be algorithmic, and take into consideration factors such as frequency of positive and negative terms occurring near the subject of the text content. In some implementations, the individual sentiment scores of the terms may also be aggregated, and optionally weighted to account for proximity to the subject. An overall sentiment value may reflect the user sentiment for a particular subject, such as a sponsor's business. In determining the sentiment values, the sentiment score for select salient terms may be determined. Algorithmic input, such as weighting or other calculations, may also be employed to calculate a sentiment value reflecting user sentiment for the subject or category of the content, based on the sentiment score of individual terms.

The system can also be configured to recognize and account for emoticons that are incorporated by users in interactions. Emoticons, or specific characters relating to an emotional sentiment (e.g. posting a smiley face in a post or comment indicates a positive emotional tie) can be assigned point values. For example, a sponsor can tell users (who can also access this information on their user portal) that *.*=positive reaction, (<>)=negative reaction, and that they each get a predetermined number of points every time they use one of these to indicate how they feel about a post or photo, etc. The system can track these as a way to assign emotional reactions.

Virtualized Focus Groups

The systems and methods described herein can be used in connection with crowd-sourced virtual focus groups, or stakeholder forums, within social media. The systems and methods can be used to solicit feedback from large customer samples on a range of issues. Companies can use the system to ask customers to react to questions about their products and offer their own substantive recommendations for improvements. As a result, users may feel a stronger sense of community and collective ownership while providing unique insights to the company. Because the system is virtualized, these functions can be performed by remote users. This allows companies to get customers working for them on innovative solutions, and provides a forum through which the company can directly respond and contribute to the conversation. This relationship can demonstrate a unique level of customer care and engagement that can help to define a brand in a positive light.

Thus, users can participate in a focus group without needing to be present in a brick and mortar establishment. As a result, a company can use the system to run focus groups with relatively larger samples at a relatively lower cost.

For example, Company A may run a promotion on a Facebook™ page requesting feedback from customers about airline food options. The system can be configured so that the company can let customers identify problems or provide one or more specific problems the customer would like to fix. The customers then can start conversation threads and/or Facebook™documents about their ideas to improve the company offering. The system can be configured to award points for contributing to these conversations, thus incentivizing users to participate.

As an example:

A first customer post could be:
It would be great if we had more fresh options for food—such as fruit and vegetables.
A second customer could post:
Yes! Totally agreed, I'd definitely be willing to pay a bit more in-flight for fresh fruit.
An arbitrarily large number of follow up posts indicating wide support for this idea might follow.
A company representative could respond:
Thanks for this great feedback—we want to dig deeper here. It would of course, cost more to get fresh fruit—but let me ask some hypothetical questions. How much would you view as a fair price to buy 1) a fruit arrangement of two apples and one orange 2) a vegetable and dip plate?
A first customer might reply:
I'd pay $5 for either.
And a second customer might reply:
$4.50 and $5

This conversational exchange could continue for any number of posts, any number of times.

The company may achieve several benefits. For example: 1) The company can receive honest (incentive structure provides nothing to dissuade honest feedback) feedback from a limitless sample size; 2) The company can get very good and innovative ideas from the customer; 3) The company could ask customers to identify for them what they see as issues that need to be addressed; 4) The conversation is two-way. If a company is willing to have this conversation publicly, they are being truly transparent, and also directly replying to the customer feedback. This can define a brand as people will respond well to being invited inside the decision making process and this may further help develop a sense of collective ownership and affinity with the brand.

Database Backend

The system may be embodied as an application which accesses the social media platform through an API provided by the platform. The APIs can allow the incentive system to access the content of the social media interactions of the participating users. The data received through the API may be stored at a centralized server.

The system can be configured so that the sponsor can host it, or the system provider can host it. An application interfacing with the social media network can send information about the social media interactions to a centralized database. As points are accumulated by users, the data representing the points can be stored in the database backend.

System Modules

As non-limiting examples, system modules can include:

Point Collection Module: The code corresponding to the actions and algorithms that collect points from Facebook™ for different activities (e.g., posting, commenting, liking) within Facebook™.

Conversation Module: The code corresponding to the conversational functionality which allocates different point values to users based on follow up comments and likes from other users in an ongoing discussion thread, and allows users to accumulate additional points as follow up comments are added to the conversation thread.

Administrative Backend Module: The code corresponding to the administrative backend and mirror Facebook™ wall and scoreboard.

Activity Modules: The code corresponding to the starting and stopping of activity cycles.

Collection and Export Modules: The code corresponding to the collection and export of activity metrics and analytics.

Facebook™ Authentication Module: The code corresponding to the Facebook™ login process that integrates users into the point system.

Post Removal Module: The code corresponding to the removal of posts/comments/likes and subsequent deletion of points.

Communication Module: The code corresponding to the communication between the Application, Facebook™, and the administrative backend.

Point Leaderboard Module: The code corresponding to the Point leaderboard in the administrative backend.

Client Software Embodiments

The client software can be configured to execute on a client computing device. The client computing device can be any form of desktop or mobile computing device. Some embodiments of the system can interoperate with a resource-constrained device, such as, for example, a mobile communications device, PDA, mobile phone or tablet. Non-limiting examples include computers running Windows™, MacOS™, iOS™, and Android™ operating systems.

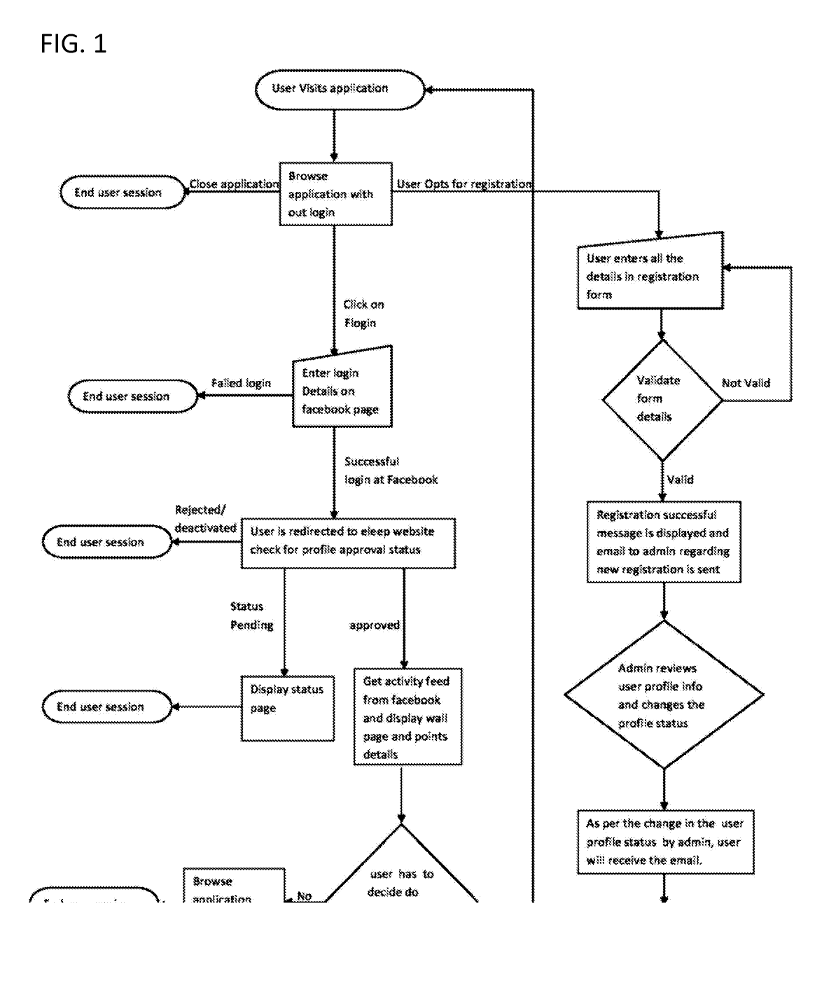

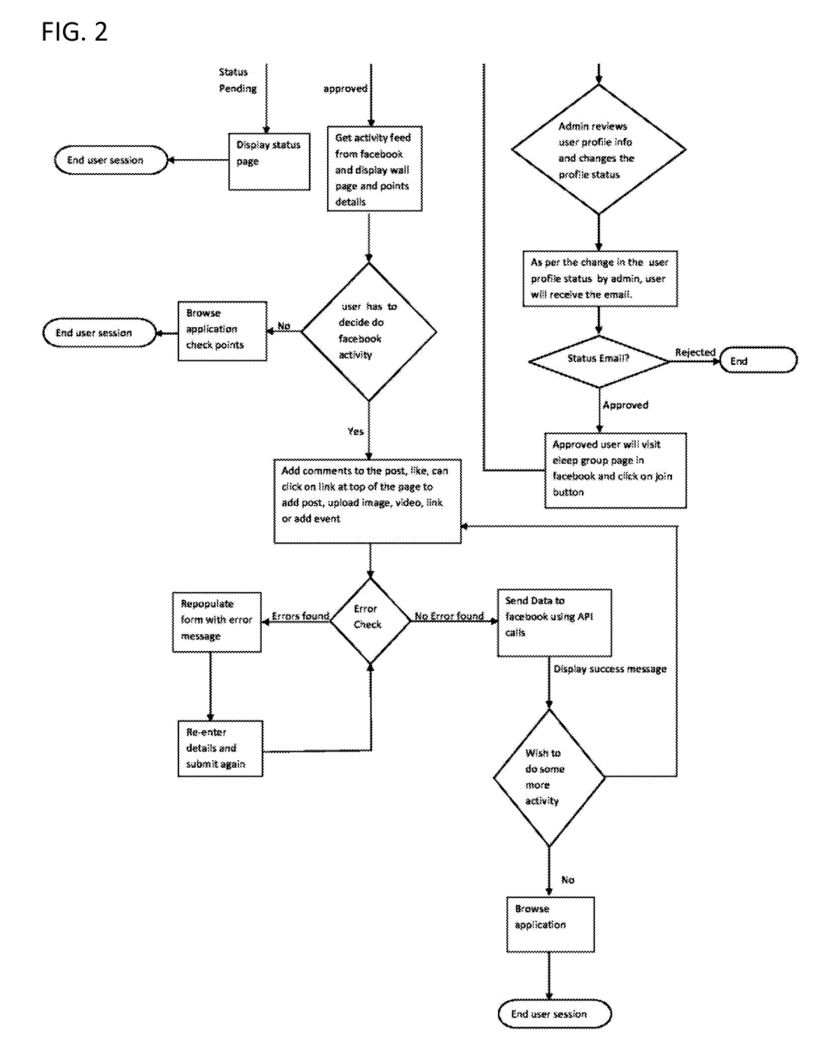

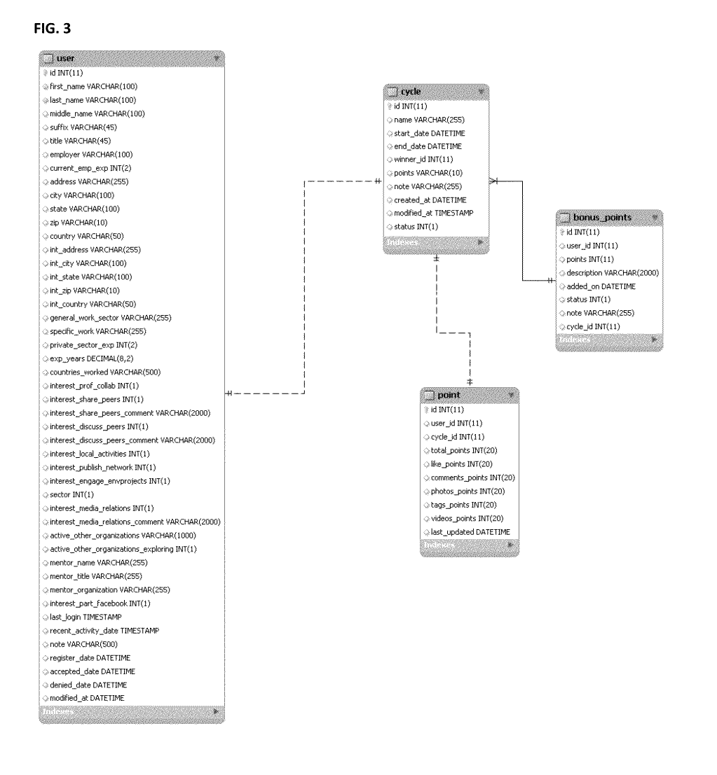

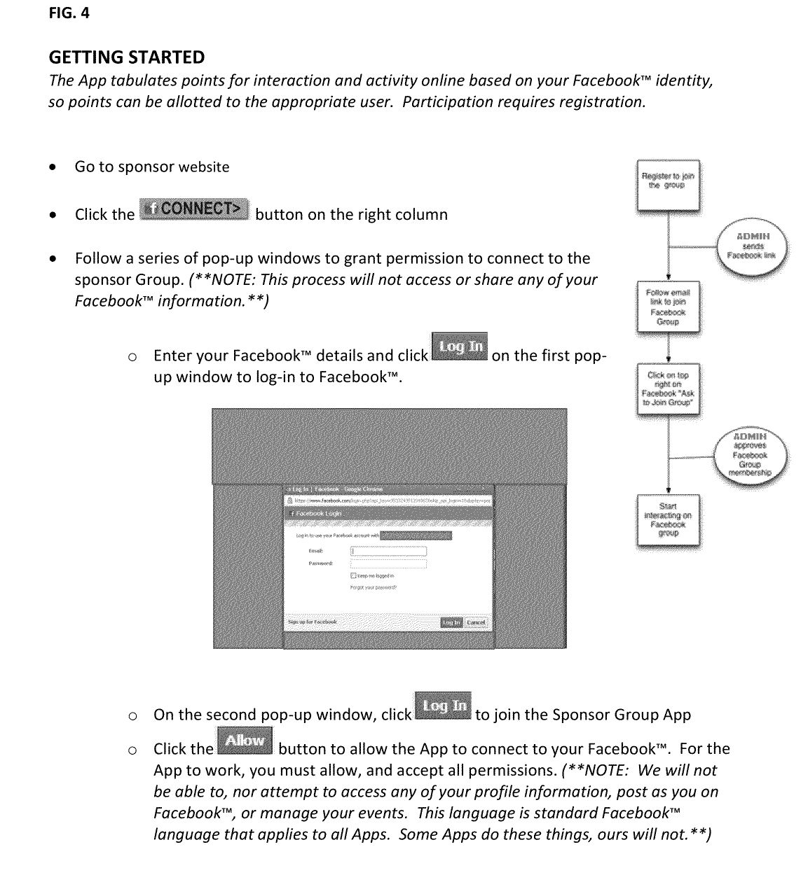

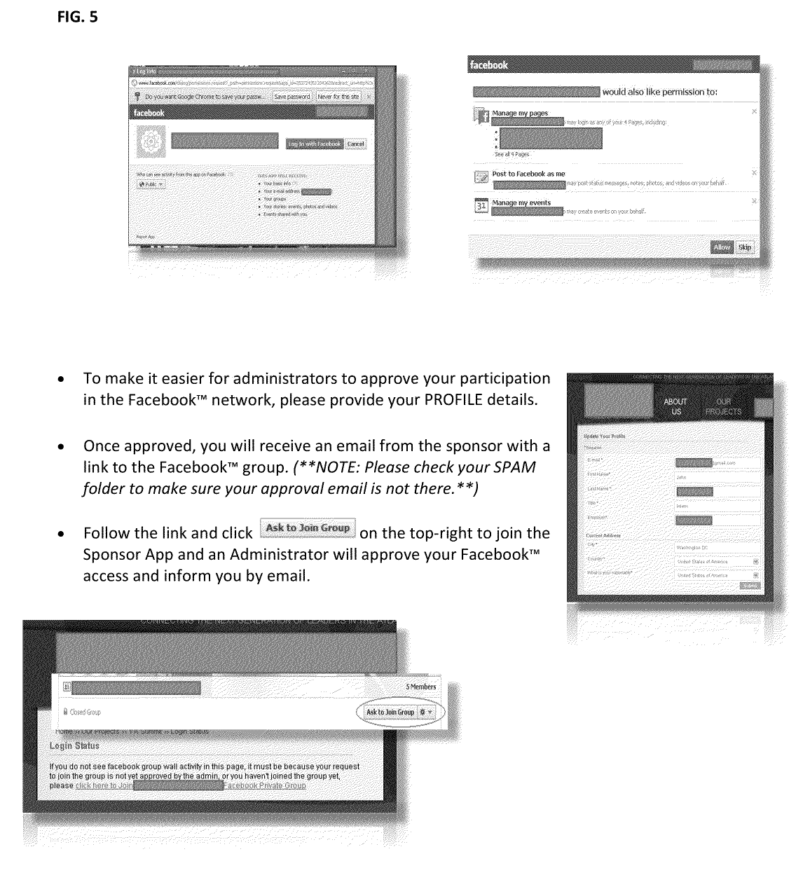

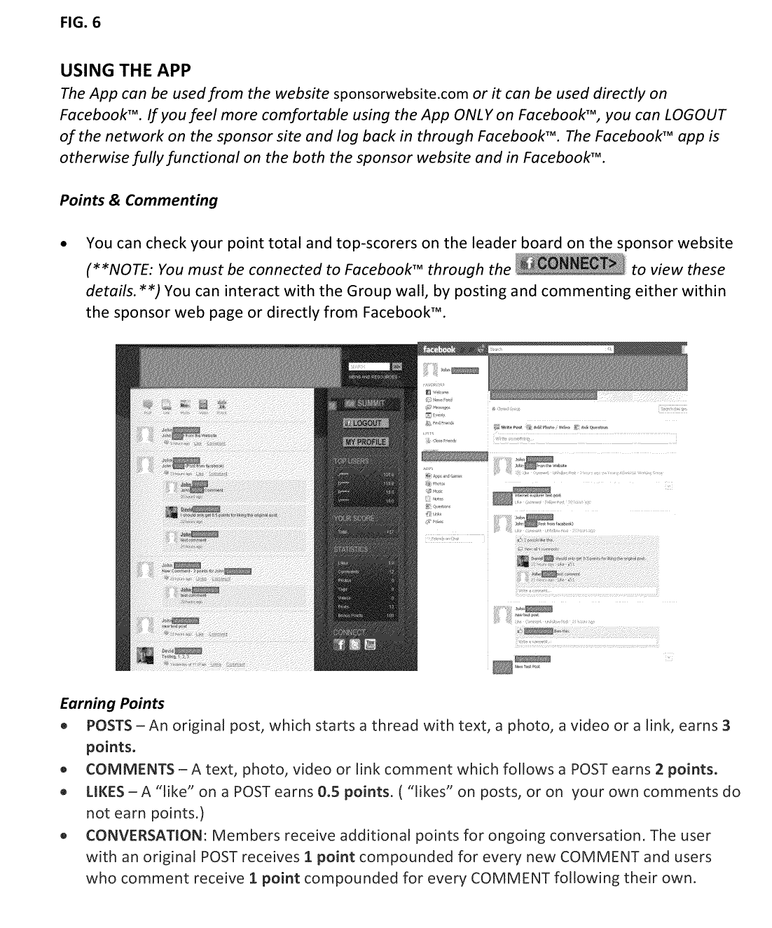

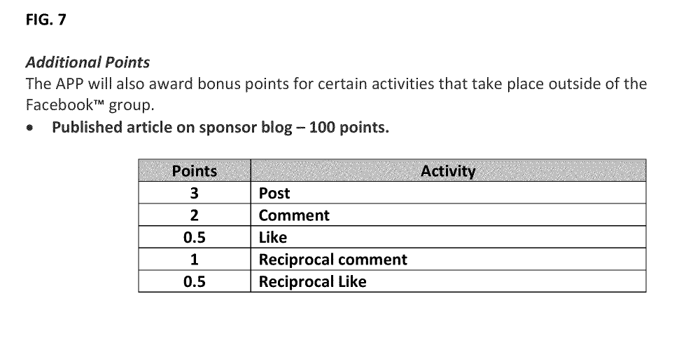

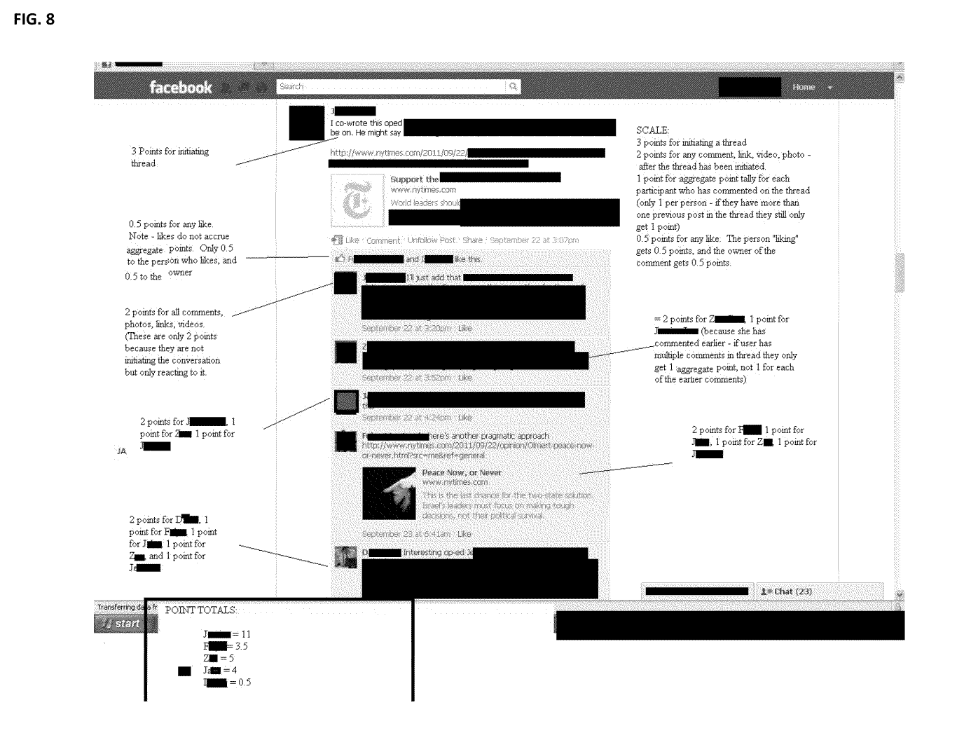

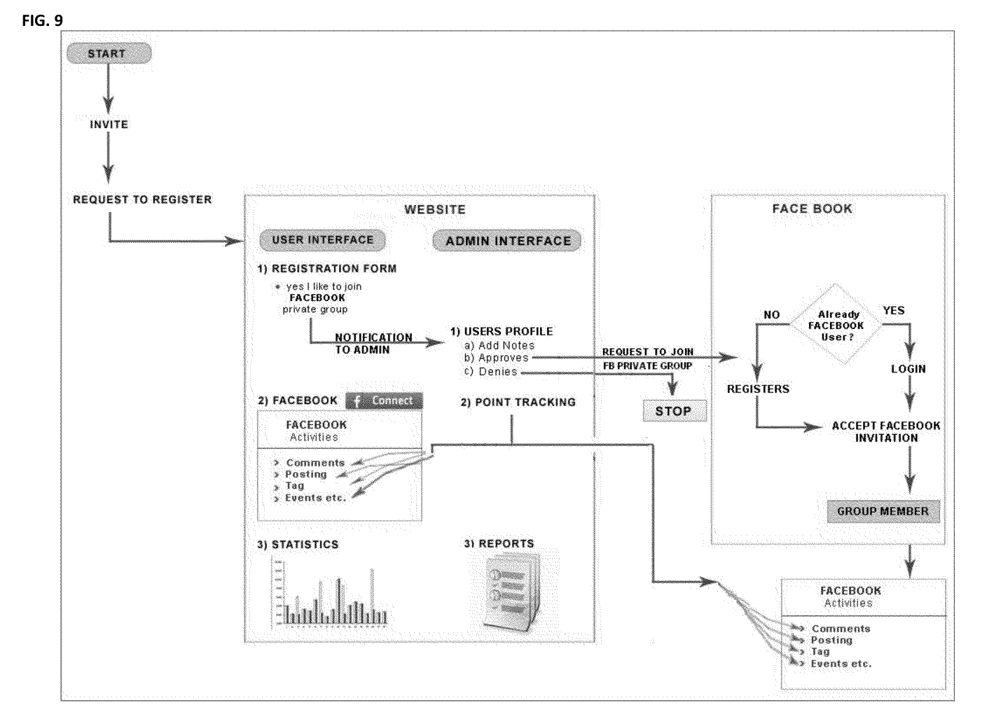

FIGS. 1 and 2 illustrate a flow diagram for social media engagement and point management. FIG. 3 illustrates an example database structure for managing the system. FIGS. 4-8 illustrate example modes of operation of the system. FIG. 9 illustrates an example system and method for social media point tracking.

System Architectures

The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions.

The methods can be implemented in a computer program product accessible from a computer-usable or computer-readable storage medium providing program code for use by or in connection with a computer or any instruction execution system. A computer-usable or computer-readable storage medium can be any apparatus that can contain or store the program for use by or in connection with the instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer having a display device such as a CRT (cathode ray tube), LCD (liquid crystal display), or other type of monitor for displaying information to the user and a keyboard and an input device, such as a mouse or a trackball by which the user can provide input to the computer.

A computer program can be a set of instructions that can be used, directly or indirectly, in a computer. The systems and methods described herein can be implemented using programming languages, systems, and frameworks such as Flash™, JAVA™, C++, C, C#, Visual Basic™, JavaScript™, PHP, XML, HTML, Zend Framework, MySQL, Facebook™Graph API, Fusion Charts, etc., or a combination of programming languages, including compiled or interpreted languages, and it can be deployed in any form, including as a stand-alone program or as a module, component, subroutine, or other unit suitable for use in a computing environment. The software can include, but is not limited to firmware, resident software, microcode, etc. Protocols such as SOAP/HTTP may be used in implementing interfaces between programming modules. The components and functionality described herein may be implemented on any desktop operating system such as different versions of Microsoft Windows™, Apple™ Mac™, iOS™, Unix™/X-Windows™, Linux™, etc., executing in a virtualized or non-virtualized environment, using any programming language suitable for software development.

Suitable processors for the execution of a program of instructions include, by way of example, both general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform, or host. The virtual machine can have both virtual system hardware and guest operating system software.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

One or more embodiments of the invention may be practiced with other computer system configurations including hand-held devices, microprocessor systems, microprocessor-based or programmable consumer electronics, minicomputers, mainframe computers and the like. The invention may also be practiced in distributed computing environments where tasks are performed by remote processing devices that are linked through a network. While one or more embodiments of the present invention have been described, various alterations, additions, permutations and equivalents thereof are included within the scope of the invention.

What is claimed is:

1. A computerized method for managing points awarded based on social media engagement, the method comprising:
electronically storing a plurality of specified social media interaction types and associated point values in a computerized database;
awarding a first point value to a first user based on a first social media interaction of a first specified type, the first point value being based on the first social media interaction type;
awarding a different point value not equal to the first point value to a second user based on a second social media interaction associated with the first social media interaction and of a second specified type, the second point value being based on the second social media interaction type;
calculating, by a computerized processor, an accumulated point value for the first user; and
storing the accumulated point total value for the first user in a computerized data store.

2. The method of claim 1, wherein the point values are pre-assigned.

3. The method of claim 1, wherein the point values are calculated based on initial parameters.

4. The method of claim 1, wherein the point values are calculated during execution of the program.

5. The method of claim 1, wherein the point values are awarded for posting multimedia content, for tagging individual users, or checking in.

6. The method of claim 1, wherein different types of interactions are assigned different point values.

7. The method of claim 1, wherein points are awarded for offline events which are recorded by manual entry.

8. The method of claim 1, wherein the points represent value accretion.

9. The method of claim 1, further comprising providing a computerized administration interface for editing the number of points awarded for specified activities.

10. The method of claim 1, further comprising awarding direct points based on a posting by a user.

11. The method of claim 1, further comprising awarding indirect points based on subsequent engagement with a first post by another user.

12. The method of claim 1, further comprising awarding conversational points based on a series of enagements.

13. The method of claim 1, wherein the point value awarded to an original post is greater than the point value awarded to a subsequent post associated with the original post.

14. The method of claim 1, further comprising awarding a different point value (y) not equal to the first point value to a second user based on a follow-up social media interaction from another user in an ongoing discussion thread such that a predetermined number of points (x) are awarded for originating a post in a discussion, (y) points are awarded for liking a discussion, and (z) points are awarded for posting a follow-up comment in a discussion, and wherein the point values (x), (y) and (z) are not equal to each other.
